(19) United States
(12) Patent Application Publication
(10) Pub. No.: US 2012/0143692 A1
(43) Pub. Date: Jun. 7, 2012

(54) SYSTEMS AND METHODS FOR DELIVERING ADVERTISING AND INCENTIVIZING CONSUMERS TO RECEIVE ADVERTISING

(76) Inventor: Chad N. Packer, Layton, UT (US)

(21) Appl. No.: 13/309,086

(22) Filed: Dec. 1, 2011

Related U.S. Application Data
(60) Provisional application No. 61/419,188, filed on Dec. 2, 2010.

(51) Int. Cl. G06Q 30/02

(52) U.S. Cl. 705/14.64; 705/14.49

(57) ABSTRACT

The present invention extends to methods, systems, and computer program products for delivering advertising messages from advertisers while incentivizing consumers to receive the advertising messages. In some embodiments, a provider selects a consumer to receive advertising content from an advertiser, sends a message to a portable device for the consumer, and provides a financial incentive to the consumer for receiving the message. In other embodiments, a provider determines that a consumer qualifies to receive an advertisement based on target consumer criteria and sends the advertisement to the consumer. The provider also receives payment from the advertiser and shares the payment with the consumer by providing a reward to the consumer. In additional embodiments, a provider accesses aggregate consumer information relating to a plurality of consumers to select consumers to receive advertising content, sends an advertisement to the selected consumers, and provides an incentive to the selected consumers.

### CROSS-REFERENCE TO RELATED APPLICATIONS

This application claims priority to and the benefit of U.S. Provisional Application No. 61/419,188, filed Dec. 2, 2010, and entitled “SYSTEMS AND METHODS FOR DELIVERING ADVERTISING AND INCENTIVIZING CONSUMERS TO RECEIVE ADVERTISING,” the disclosure of which is incorporated herein in its entirety.

### BACKGROUND

Mobile phones offer the benefits of allowing consumers to move about and engage in any number of different activities, without having to be present at a particular location (e.g., a home or office) to receive a phone call. At least in part due to the convenience of mobile phones, it is estimated that more than one in every five households now opts to forego a landline phone altogether.

Mobile phones provide numerous features other than merely use as a phone to facilitate conversation. Mobile phones themselves include additional features such as games, calendars, calculators, and the like that effectively turn the phones into portable computing devices. Moreover, mobile phone providers offer additional services in connection with mobile phones. For instance, a mobile phone provider may offer data services through which mobile phone users can receive email or text messages. Through data services, users may also access networks or third party resources to browse the Internet, to access virtual private networks, or to otherwise access data.

A more recent phenomenon is the popularity of text messaging, particularly among the youth. As such, even without telephonic conversation, acquaintances may communicate via text messages. Other uses of text messaging including receiving sports scores, receiving weather reports, obtaining RSS feed updates, and even ordering food. In still other cases, text messages may be sent as advertisements.

While some text messaging plans offer unlimited messages, most text messaging plans offer only a limited number of messages per month. Some mobile phones may have no text messaging plan, charging users on a per-message basis. If a mobile phone receives a text message that is not covered by a messaging plan, the phone carrier may charge the user a significant amount of money to receive the message (e.g., five to twenty cents). As such, advertisers may be reluctant to send out mass text messages to mobile phones, as they risk causing consumers to actually pay to receive the advertising—which may alienate consumers rather than draw them towards the advertisers' products or services. Additionally, advertisers may have difficulty targeting the advertisement to a desired demographic or audience.

Advertisers may also want to target consumers by sending advertisements to consumers by means other than text messaging to mobile phones. Often, however, consumers will enter incorrect contact information when signing up for a service to avoid unwanted messages (i.e., spam) which may be sent to the consumer's email address, home address, etc.

### BRIEF SUMMARY

The present invention extends to methods, systems, and computer program products for delivering messages from advertisers. More particularly, embodiments of the present invention relate to distributing advertising messages to consumers who authorize delivery of the advertisements, in a manner that incentivizes the consumers to receive the advertisements.

In one embodiment, a computer system accesses text message advertisement information provided by an advertiser. Then, using consumer information, the computer system selects consumers to receive advertising content from the advertisement information. The computer system sends a text message to a device for each selected consumer. Each text message includes the advertising content provided by the advertiser. The computer system also provides at least one of the consumers with an incentive. The incentive relates directly to receipt of the sent text message by the consumer.

In another embodiment, a computer system receives registration information from a consumer. The registration information includes consent by the consumer to receive electronic advertisements. The computer system also receives an electronic advertisement and target consumer criteria from an advertiser. The computer system determines that the consumer qualifies to receive the text advertisement, and transmits the electronic advertisement to a portable device of the consumer. The computer system also receives payment from the advertiser, and shares the received payment with the consumer by providing a reward to the consumer.

In yet another embodiment, a computer system accesses advertisement information received from an advertiser. The advertisement information includes advertising content and consumer criteria. The computer system also accesses aggregate consumer information, which relates to a plurality of consumers. The computer system compares the consumer criteria with the aggregate consumer information and selects consumer(s) to receive the advertising content. The computer system sends an advertisement, which includes at least some of the advertising content, to the selected consumer(s).

Additional features and advantages of the embodiments disclosed herein and which may be learned from a practice of the disclosure herein will be set forth in the description which follows, and in part will be obvious from the description, or may be learned by the practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth hereinafter.

### BRIEF DESCRIPTION OF THE DRAWINGS

To further clarify various aspects of embodiments of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope, nor are the figures necessarily drawn to scale. The embodiments of the present disclosure will be described and explained with additional specificity and detail through the use of the accompanying drawings in which:

FIG. 1 illustrates an example advertisement distribution and incentive system that facilitates delivering advertisers' messages to consumers while incentivizing the consumers to receive the messages;

FIG. 2 illustrates an example embodiment of a provider system for receiving advertising content and delivering the advertising content to one or more consumers;

FIG. 3 illustrates a flowchart of an exemplary method for transmitting advertisements to devices capable of receiving advertising content; and

FIG. 4 illustrates a flowchart of another exemplary method for delivering advertising to a consumer and providing to the consumer incentives to receive the delivered advertising.

### DETAILED DESCRIPTION

The present invention extends to methods, systems, and computer program products for delivering messages from advertisers. More particularly, embodiments of the present invention relate to distributing advertising messages to consumers who authorize delivery of the advertisements, in a manner that incentivizes the consumers to receive the advertisements.

In one embodiment, a computer system accesses text message advertisement information provided by an advertiser. Then, using consumer information, the computer system selects consumers to receive advertising content from the advertisement information. The computer system sends a text message to a device for each selected consumer. Each text message includes the advertising content provided by the advertiser. The computer system also provides at least one of the consumers with an incentive. The incentive relates directly to receipt of the sent text message by the consumer.

In another embodiment, a computer system receives registration information from a consumer. The registration information includes consent by the consumer to receive electronic advertisements. The computer system also receives an electronic advertisement and target consumer criteria from an advertiser. The computer system determines that the consumer qualifies to receive the electronic advertisement, and transmits the electronic advertisement to a portable device of the consumer. The computer system also receives payment from the advertiser, and shares the received payment with the consumer by providing a reward to the consumer.

In yet another embodiment, a computer system accesses advertisement information received from an advertiser. The advertisement information includes advertising content and consumer criteria. The computer system also accesses aggregate consumer information, which relates to a plurality of consumers. The computer system compares the consumer criteria with the aggregate consumer information and selects consumer(s) to receive the advertising content. The computer system sends an advertisement, which includes at least some of the advertising content, to the selected consumer(s).

Exemplary embodiments of the present disclosure are therefore directed to methods, systems, and computer program products which facilitate one or more of: (i) incentive programs by which consumers elect to receive text message advertisements and receive a benefit for receiving the advertisements; (ii) targeting of advertisements to a desired audience, which audience may be based on demographic information, interest data, or the like; (iii) payment systems by which a monetary payment or other remuneration is delivered to a recipient of text messages; or (iv) text message delivery systems by which an intermediary transparently delivers text messages on behalf of an advertiser and shares an incentive with the consumer.

Embodiments include an advertising service provider that acts as an intermediary between advertisers and consumers. The provider can provide an interface through which consumers may register or otherwise agree to receive advertisements in exchange for incentives having values based on the number of advertisements received. The interface may allow consumers to enter contact information as well as demographic information, hobbies, interests, advertisement delivery time/date information, maximum advertisement information, and the like. Advertisers have access to the same or a different interface, through which advertisers supply the provider with advertising content. Advertisers also supply target consumer criteria. The target consumer criteria may identify demographics, hobbies, interests, and/or other information of the target consumers, as well as the number of advertisements to be sent, the date/time when advertisements should be delivered/sent, or the like.

Based on the consumer and advertiser information, consumers can be matched with advertisements. Delivery of the advertisements may be scheduled to coincide with the preferences set by the consumers and/or the advertisers, and may be transparent to the advertiser such that the advertiser is unaware of the identity or contact information of the consumers receiving the advertisement. Advertisers may provide payment for the provider to send the advertisements. Based on the number of advertisements received by the consumer, the provider may share revenue or otherwise provide a monetary or other incentive with the consumer.

In some embodiments, text messages include an option to reply to the message. Upon receipt of a response to the advertisement, the provider may determine that the consumer has authorized sharing of the consumer's personal information with the advertiser, and the consumer's personal information is sent to the advertiser. Alternatively, upon receipt of a response to the advertisement, the provider may determine that the consumer would like to discontinue advertisements from this advertiser, or otherwise use the response data for processing other requests from advertisers.

As defined herein, a “text message” includes any message sent to a consumer's device, regardless of the message format or the delivery mechanism. For example, a text message can comprise any of a Short Message Service (“SMS”) message, a Multimedia Messaging Service (MMS) message, an email, a chatting protocol (e.g., AOL Messenger, MSN Messenger, Google Talk, Jabber, etc.) message, or any other type of message whether using known technologies or technologies yet to be developed.

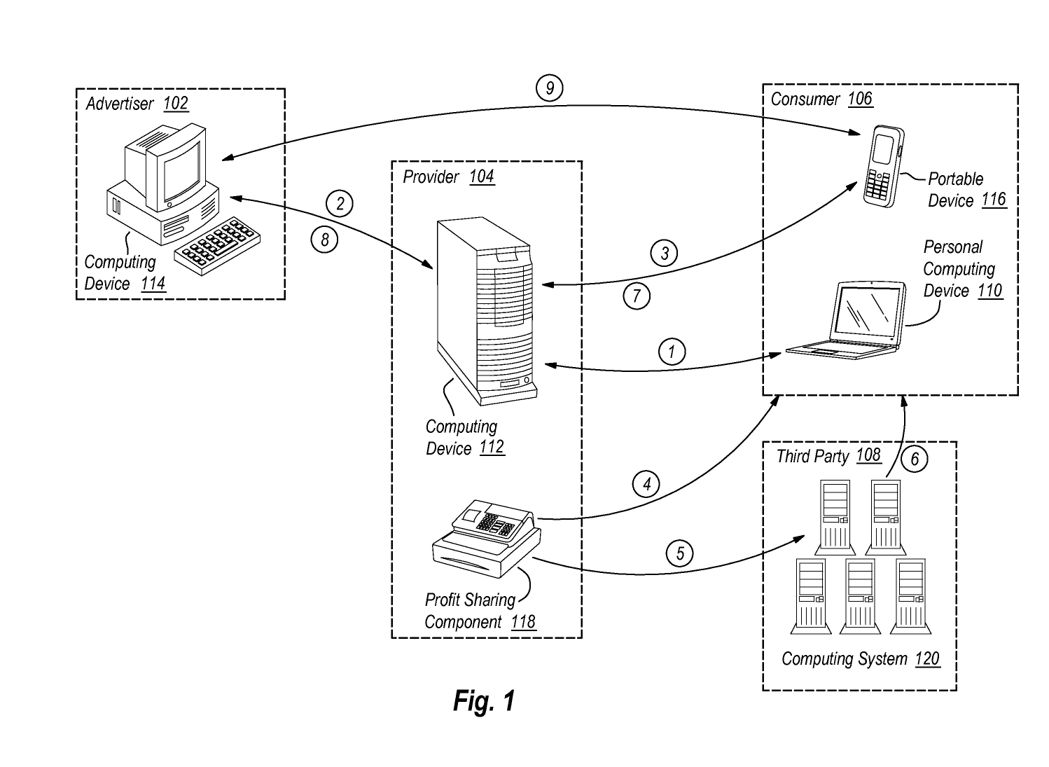

FIG. 1 illustrates an example advertisement distribution and incentive system 100 that facilitates delivering advertisers' text messages to consumers while incentivizing the consumers to receive the text messages. Referring to FIG. 1, system 100 includes variety of entities, including advertiser 102, provider 104, and consumer 106. Correspondingly, system 100 includes computing device 114 of advertiser 102, computing device 112 of provider 104 and portable device 116 of consumer 106. Each of the depicted computer systems is connected to one another over (or is part of) one or more wired or wireless networks, such as, for example, Local Area Networks (“LANs”), Wide Area Networks (“WANs”), and even the Internet. Accordingly, each of the depicted computer systems as well as any other connected computer systems and their components, can create message related data and exchange message related data (e.g., SMS and/or MMS protocols, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over any network(s).

Advertiser 102 interacts with provider 104 so as to allow provider 104 to facilitate distribution of advertising text or other electronic messages (e.g., SMS, MMS, email, etc) to consumer 106. FIG. 1 also illustrates third party 108 within system 100. Third party 108 may represent various types of third parties, including third parties that store or process data.

According to some embodiments, advertiser 102 may comprise a commercial or other entity desiring to send text messages to portable devices of consumers, such as portable device 116 of consumer 106. Such a commercial entity may include, for instance, a restaurant, a department store, a web site, a service provider, or any other entity (or any combination of the foregoing) that may find it desirable to market goods, services, or other products to consumer 106 through text messages to portable device 116. As described in greater detail hereafter, in some embodiments, at least some of the text messages sent to consumer 106 at the request of advertiser 102 may be sent through provider 104. For example, provider 104 may provide an interface (e.g., a web site, an Application Programming Interface (“API”), and the like) through which advertiser 102 can interact (e.g., to specify the text of the text message to be sent). Provider 104 may then identify which one or more consumers should be the recipients of the provided text message. Accordingly advertiser 102 may use provider 104 to send text messages, and the identity of consumer 106 may remain unknown to advertiser 102.

As indicated, advertiser 102, provider 104, consumer 106, and any third party 108 may have one or more computing devices that communicate within system 100. For example, consumer 106 may have one or more devices capable of receiving text messages. As depicted, consumer 106 has portable device 116 and personal computing device 110, either or both of which may receive text messages. Portable device 116 may, for example, be a mobile phone, a smart phone, a GPS receiver/transmitter, or another similar device. Portable device 116 may even comprise a desktop or laptop computer.

Portable device 116 of consumer 106 may be connected to computing device 112 of provider 104 through one or more communications links. Such link(s) may include hardwired and/or wireless technology. If portable device 116 is a mobile phone, portable device 116 may use cellular or other wireless technology to communicate over a communications link with computing device 112. Personal computing device 110 may also interact with computing device 112. While personal computing device 110 and portable device 116 of consumer 106 are illustrated as two separate devices, consumer 106 may use more or fewer devices to communicate with provider 104. In at least one embodiment, portable device 116 may include software, firmware, hardware, or any combination thereof that enable portable device 116 to operate as both a telephone and a computing device. For example, portable device 116 may be able to connect to the Internet and/or may run one or more applications that facilitate communication with provider 104.

System 100 may be used to supply text messages to consumer 106, and optionally to incentivize the 106 to receive the text messages. For example, consumer 106 may initiate communication with, or otherwise contact, provider 104. As depicted, consumer 106 and provider 104 may communicate through communications link 1. Through communications link 1, consumer 106 may indicate a desire to receive advertisements from one or more advertisers as text messages. For example, consumer 106 may initiate a registration process with provider 104. In a registration process, consumer 106 may provide contact information (e.g., a telephone number, an e-mail address, etc.) through which consumer 106 can receive text messages, emails, or other advertising communications.

In addition, provider 104 may also communicate with one or more advertisers that wish to send advertisements (e.g., through computing device 112). Advertiser 102 is exemplary of one such advertiser that may wish to send text message, email, or other advertisements. Through computing device 114, advertiser 102 may communicate with computing device 112 at provider 104. As depicted, for example, computing devices 112 and 114 communicate through communications link 2. Through communications link 2, advertiser 102 may register or otherwise indicate a desire to send one or more advertisements to consumers, and a desire to enlist the assistance of provider 104 in directing or sending such advertisements. Also through communications link 2, advertiser 102 may be able to request that a single advertisement be distributed to a single consumer or to multiple consumers. For example, advertiser 102 may be able to request that an advertisement be sent to hundreds or even thousands of consumers.

In some embodiments, provider 104 offers a service which advertiser 102 pays to use. For example, provider 104 may maintain a listing of numerous consumers, along with their contact information. The names and contact information of the consumers may be at least temporarily withheld from advertiser 102. With the stored contact information, provider 104 may optionally store other appropriate information. For example, consumer 106 may provide demographic information or information about interests, hobbies, availability, and the like to provider 104.

When provider 104 has received sufficient information to identify an advertisement that advertiser 102 wishes to send, provider 104 can use information about consumers to determine which consumer(s) to target with the advertisement. In some embodiments, advertiser 102 may specify criteria about whom the advertisement is sent. For example, advertiser 102 may wish to target only consumers that reside in certain geographical areas, or that are of a certain age, gender, ethnicity, etc., or combinations thereof. Advertiser 102 may even target only consumers who self-identify as having particular interests or hobbies (e.g., sewing, sports, rock climbing, etc.). Accordingly, using information that provider 104 has about various consumers, provider 104 provide an effective means of targeting a particular audience with which advertiser 102 wishes to communicate.

When advertiser 102 has specified what message to include in an advertisement, and optionally to whom the message should be targeted, provider 104 may access the consumer information and identify consumers to target. In some circumstances, advertiser 102 may request that only a limited number of advertisements be sent. For example, advertiser 102 may, in an initial request, specify that “n” number of consumers receive the advertisement. In these circumstances, provider 104 may identify the best “n” candidates, and send the advertisement to the identified candidates (e.g., via communications link 3 in the form of a text message (e.g., SMS, MMS, etc.), email, Interactive Voice Response (“IVR”), or other mechanism). In other circumstances, provider 104 may send to advertiser 102 a number indicating how many consumers matched specified criteria (e.g., geographic criteria, demographic criteria, etc.). Based on that number, advertiser 102 may determine whether to send the advertisement to some, or all, of the matching consumers.

In embodiments in which provider 104 is a pay-to-use service, advertisers may pay provider 104 to send advertisements. In some embodiments, advertiser 102 may pay a certain amount (e.g., between $0.01 and $0.50) per consumer to which provider 104 directs an advertisement, although such payment mechanism is merely exemplary. In other embodiments, advertiser 102 may pay based on a flat fee, a bulk payment bracket, or on some other payment schedule or plan. Regardless of the particular payment structure, such cost may vary based on a number of factors. Factors may include, for example, the degree to which the advertisement is specifically tailored to a particular demographic or group, the length of the advertisement, the content of the message, the type of advertising plan advertiser 102 has with provider 104, or a combination of the foregoing or other factors.

Payment information may be transmitted from computing device 114 of advertiser 102 to computing device 112 of provider 104 (e.g., via communications link 2). Provider 104 may then charge advertiser 102 based on the number of advertisements sent to consumers on behalf of provider 104, or based on some other payment scheme. The charges may be applied immediately upon confirmation from advertiser 102 that it wishes to send the advertisements, or may be delayed. For example, charges may be applied at the time the last advertisement is sent out, or a certain time after all advertisements have been sent out (so as to remove charges for any advertisements that do not reach the intended recipient, for example). If some advertisements “bounce-back,” provider 104 may, in some embodiments, review the available consumers and find one or more replacement consumers to receive the advertisements. Additionally, or alternatively, provider 104 may apply a credit to an advertiser's next advertisement purchase, may issue a cash refund, or may provide some other refund mechanism.

When a particular consumer (e.g., consumer 106) has been identified as a consumer matching criteria specified by advertiser 102, provider 104 may send the advertisement to consumer 106. For example, in some embodiments, the advertisement is in the form of a text message sent to portable device 116 (e.g., a mobile phone, a portable audio device, a tablet computer) of consumer 106.

As noted previously, system 100 can, in some embodiments, incentivize consumers to receive text messages or other advertisements. According to at least one embodiment, consumers who agree to receive advertisements may receive financial or other incentives for doing so. As noted, provider 104 may charge advertisers for the service of matching consumers with advertisements and/or for sending out advertisements on behalf of the advertisers. In some embodiments, therefore, a portion of the payment made by advertisers to provider 104 for said service may be shared with consumers. For example, if advertiser 102 is willing to pay provider 104 eighty cents for each advertisement sent to a consumer, provider 104 may agree to provide half of that payment to each consumer receiving the advertisement. Thus, consumer 106 may be awarded forty cents when the advertisement is sent to mobile device 116. The foregoing is merely exemplary, however. In other embodiments, the distribution of revenue may be accounted for in other manners. For example, consumer 106 may receive more or less than half the per-advertisement payment by advertiser 102.

When system 100 includes an incentive or profit sharing functionality, provider 104 may include profit sharing component 118. Profit sharing component 118 may be separate from, or incorporated with, computing device 112 of provider 104. In some embodiments, profit sharing component 118 may be used to provide direct financial incentives to consumer 106. For example, after consumer 106 has received a certain number of advertisements, or after consumer 106 has earned a certain amount of money, profit sharing component 118 may initiate the printing of a check or otherwise provide payment to consumer 106. For example, a check or other payment may be sent to the consumer 106 (e.g., via communications link 4) either physically or electronically. Compensation or incentives do not have to be strictly in the form of currency or its equivalent. For example, vouchers to certain stores, restaurants, etc. may be provided in lieu of cash or cash equivalents. In some embodiments, consumer 106 may choose between different compensation schemes.

According to some embodiments, profit sharing component 118 may directly compensate consumer 106. For example, cash, cash equivalents, vouchers, discount cards, gift cards, etc. can be sent directly to consumer 106, can be credited to a bank or other account, or the like. In other embodiments, provider 104 may indirectly compensate consumer 106. As depicted in FIG. 1, for example, provider 104 may communicate with one or more third parties 108. Third party 108 may provide incentives or other compensation to consumer 106. For example, third party 108 may be a retailer, restaurant, or other merchant. After consumer 106 has received a certain number of advertisements or has accumulated a certain monetary value, profit sharing component 118 may communicate with third party 108 to let third party 108 know that consumer 106 is entitled to a reward or incentive. For example, provider 104 may send a message to server, server farm, or other computing device/system 120 of third party 108. The third party 108 may then issue cash or a cash equivalent, rewards, discounts, vouchers, rebates, credits, or other incentives to consumer 106. Third party 108 may then provide such incentive to consumer 106. The incentive may, for example, be mailed, to consumer 106, emailed to consumer 106, applied to a bill of consumer 106, or otherwise provided. FIG. 1 depicts that communications link 6 maybe used by third party 108 to provide incentives to consumer 106, either physically or electronically.

When third party 108 is used to at least partially incentivize consumers to receive advertisements, third party 108 may be within any number of different types of business fields. For example, the third party 108 may be a retailer or a restaurant. Third party 108 may therefore issue a gift certificate or discount for application to a purchase of the third party's products. In some embodiments, third party 108 may be a service provider. For example, mobile device 116 may be a mobile phone and third party 108 may be a mobile phone service provider. Provider 104 may send incentive information to third party 108, and third party 108 may supply incentives to consumer 106 in the form of a credit to a mobile phone service account of consumer 106. By way of example, a credit of a certain dollar amount may be applied to a mobile phone bill, thereby reducing or potentially eliminating the payment required from consumer 106 for mobile phone service. In other embodiments, provider 104 may also be a mobile phone service provider, or other provider that can directly apply a credit or other financial benefit to consumer accounts.

According to at least some embodiments, system 100 allows advertisers to direct advertisements to a desired group of consumers, allows consumers to receive advertisements of interest, allows consumers to receive financial or other benefits for receiving advertisements, and/or allows consumers to remain anonymous to advertisers. As such, provider 104 can act as a facilitator, while also ensuring that consumers' personal information is secure and private. In some embodiments, however, consumers may elect to allow advertisers to contact him or her directly. For example, after receipt of an advertisement (e.g., over communications link 3), consumer 106 may respond to an advertisement from advertiser 102 (e.g., over communications link 7). The response may also be transmitted to provider 104. For example, an advertisement may include a message such as “Reply with the phrase ‘Contact Me’ to allow the advertiser to contact you directly.” If consumer 106 replies in such a manner, provider 104 may then collect all, or a portion, of the contact information for consumer 106 and provide that contact information to advertiser 102 (e.g., via communications link 8). In some circumstances, contact information is provided to advertiser 102 only after payment of an additional fee by advertiser 102. After receipt of consumer contact information, advertiser 102 may then be enabled to directly contact consumer 106 (e.g., via communications link 9). Such contact may take the form of mail, email, text messages, phone calls, or other communication, or any combination of the foregoing.

Consumer 106 may, in some embodiments, respond to text messages to trigger other actions by provider 104. For example, consumer 106 may respond to an advertisement by including in a response the phrase “Block Advertiser.” Upon receiving such a response, provider 104 may block consumer 106 from receiving future advertisements sent on behalf of advertiser 102. Consumers may also reply in other manners. For example, an advertiser may send a two-part advertisement, with the second portion being sent only to those consumers requesting more information. Accordingly, by replying (e.g., sending a response with text such as “More Info”), provider 104 may determine that a second portion of the advertisement may be sent to the replying consumer—possibly at an additional cost to the advertiser.

As will be appreciated in view of the disclosure herein, responses by consumers may be used in any number of different manners to trigger different effects. Such effects may include distribution of contact information, provision of feedback or other information to advertisers (e.g., notifying an advertiser that a certain number or percentage of respondents replied to request more information, to block the advertiser, to indicate they were uninterested, etc.), use of a response to at least partially affect future selection of consumers for advertisements from the same or different advertisers, or any other command or result.

FIG. 1 and the discussion related thereto primarily illustrates some exemplary embodiments of an advertisement distribution and incentive system. Additional or alternative embodiments may also be included. Some such embodiments are discussed hereafter, or may otherwise be learned from practice of the disclosure herein.

While FIG. 1 illustrates various computing devices and components, it should be appreciated that such devices and components are merely for illustration and are not intended to limit the practice or scope of the present disclosure. For example, computing device 112 of provider 104 may include a server system that executes one or more programs, modules, services, routines, etc. to operate in accordance with various embodiments disclosed herein. In some embodiments, computing device 112 comprise be a single physical device, although in other embodiments, computing device 112 may comprise multiple devices. For example, computing device 112 may represent a set of servers, processors, devices, etc. that collectively operate to perform embodiments disclosed herein. In some embodiments, computing device 112 is a distributed network or cloud.

Similarly, computing device 114 of advertiser 102 may represent multiple computing devices, servers, and the like. Furthermore, while computing system 120 of third party 108 is depicted in the form of a network of multiple computing devices, computing system 120 may also be a single device, multiple devices, a localized processing system, a distributed system, a cloud, or any other suitable device, system, or network.

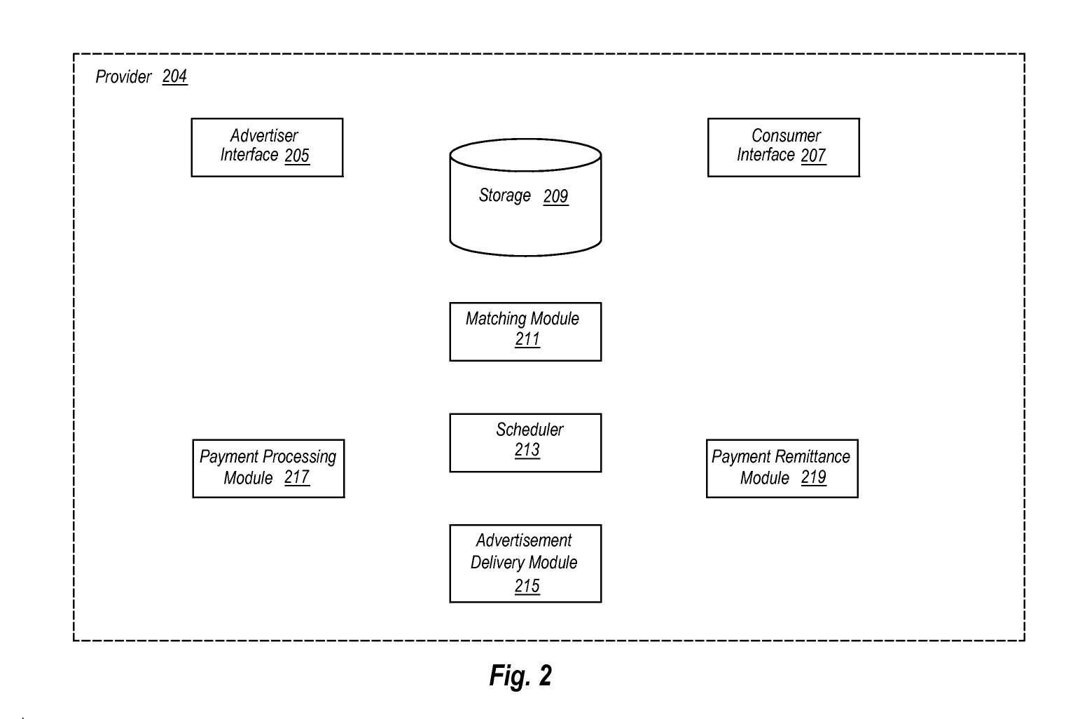

Turning now to FIG. 2, FIG. 2 illustrates a schematic diagram of an exemplary provider 204. Provider 204 may generally be similar to provider 104 of FIG. 1, and can provide similar features and functions, although more or fewer features, modules, functions, and the like can be in place for any particular embodiment consistent with the disclosure herein.

As depicted in FIG. 2, provider 204 includes advertiser interface 205 and consumer interface 207. Advertiser interface 205 may generally represent a module by which advertisers may register or otherwise provide information to provider 204. Similarly, consumer interface 207 may represent a module by which consumers may register or otherwise provide information to provider 204.

According to at least one embodiment, advertiser interface 205 can be in the form of a web application that allows advertisers to request that provider 204 send advertisements to one or more consumers on the advertisers' behalf. For example, advertisers may use interface 205 to register or otherwise identify themselves with provider 204. When an advertiser wishes to send a text message, the advertiser may log-in to advertiser interface 205, such as by using a username and password or any other appropriate identification mechanism. Through advertiser interface 205, the advertiser can select or input any number of different types of information. For example, the advertiser can input the content of an advertisement that the advertiser desired to be sent or one or more consumer devices. The advertiser may also specify the format in which the advertisement is to be relayed to consumers. Thus, the advertiser may specify that an advertisement be relayed by mail, email, SMTP, SMS, MMS, or in any other suitable format. The advertiser may also select the types of devices to which the advertisement should be relayed. For example, the advertiser may wish to only send text messages to mobile phones, or may wish to send emails to personal computing devices.

Additionally, advertisers may input information about the target audience of an advertisement. Advertisers may input information to cover a wide or small market. For example, the more specific the information input by an advertiser, the smaller the target audience will potentially become. The types of information that can be specified by advertisers are potentially unlimited. For example, an advertiser may select a particular demographic by requesting the advertisement be sent only to consumers who meet one or more criteria related to: age, gender, ethnicity, location, religion, income level, education level, disabilities, home ownership status, employment status, mobility, etc. Other information may also be available. For instance, where consumer information is available regarding consumer hobbies, interests, and the like, an advertiser may request a target audience with particular interests in one or more of: sports, sewing, camping, rock climbing, outdoor activities, genealogy, reading, movies/television shows, gardening, exercise, music, hunting, traveling, etc. Thus, advertisers may be able to define a very specific target audience or a widespread target audience. Advertisers may specify such interests to be conjunctive or disjunctive. For example, an advertiser may specify that an advertisement should be sent to one or more consumers matching any of a set of different criteria (e.g., interests include reading OR listening to music), or may be set to only send the advertisement to one or more consumers matching each of the specified criteria (e.g., interests include hunting AND camping). Any other suitable method for specifying a target consumer group may also be used.

Advertisers may input any additional information through advertiser interface 205 that is appropriate to sending advertisements. For example, advertisers may want some advertisements to have a time component. By way of example, the advertisement may relate to a promotion that extends only to a particular date/time, so an advertiser can specify that the advertisement should not be sent after a particular date or time. Advertisers may specify other time components. For example, an advertiser may specify that an advertisement should be sent only on weekends, only on Wednesdays before noon, or with any other combination of date/time criteria. For example, a restaurant may have a recurring Wednesday lunch deal, and may therefore want to target a lunchtime audience. An advertisement for a football online store may be set-up to be sent only on weekends so as to potentially attract sports fans viewing football games at the time. The foregoing examples are merely illustrative as time/date limits may be used for any number of purposes.

Through advertiser interface 205, the advertiser may also specify information related to the cost of services provided by provider 204. For example, cost may be accrued on a per-advertisement basis, and an advertiser may specify the number of advertisements for provider 204 to send. Per-advertisement or other fees may vary. For example, a tiered pricing system may be in place so that certain numbers of advertisements cost more or less than other numbers of advertisements. If advertisers wish to allow users to respond to advertisements and/or to allow their contact information to be passed directly to the advertiser, additional fees may apply.

As discussed, for example, a text message may allow the user to reply with a keyword or code, or to select a link, informing provider 204 that the consumer authorizes contact from the advertiser. Provider 204 can then pass the information on to the company or individual originating the advertisement. Authorization messages from consumers may be received from the same device to which an advertisement is sent, or from any other device. Responses may be in the form of a short code, SMTP message, email, or from a mobile communication device, home computer, or any other device.

Advertiser interface 205 may also provide a history of past advertisements sent by an advertiser, and potentially include a real-time or other listing showing in-progress advertisements and the number of advertisements that have been sent or are in the process of being sent to consumers.

According to at least one embodiment, consumer interface 207 can be in the form of a web application that allows consumers to sign-up to receive advertisements. In some embodiments, by signing-up to receive advertisements, consumers may also make themselves eligible to receive monetary, financial, or other benefits or incentives.

Through consumer interface 207, consumers can register and log-in to access account or other information. Consumer interface 207 may, for example, enable consumers to enter personal contact information, which may include the consumer's name, address, phone number, email address, and the like. Some or all of the information may be verified. For example, if a consumer is to receive text messages, then the consumer's phone number may be verified by requiring the consumer to send a text message to a particular number, or to provide a code which was sent in a text message to the consumer's phone number. A similar process may be followed for an email address. If a payment is to be mailed to a particular person and address, the name and address information may be verified.

In addition to contact information, consumers may be enabled to provide demographic and other information with consumer interface 207, such as interests or hobbies. As such, consumers can provide any data which assists provider 204 in identifying what advertisements are likely to be of interest to the consumer. Optionally, the consumer can specify whether or not such information is to be used in determining which advertisements are sent to the consumer. For example, if a consumer opts to exclude interests and hobbies from consideration in advertisement selection, text messages may be sent to that consumer only when demographic information is a match, or when a generic advertisement is sent. Similarly, if a consumer selects to exclude demographic information and interests from consideration, the consumer may be eligible only to receive generic advertisements. In short, the consumer will receive more targeted advertisements when the consumer provides more specific information about his or her interests and demographic information.

Moreover, consumers may be provided the ability to select information, preferences, advertisers, etc. for the purpose of blocking advertisements. For example, a consumer may choose to block certain types of advertisers (e.g., local advertisers, providers of certain goods or services, political polls, or the like) or may choose to expressly block specific advertisers.

Consumers may also use consumer interface 207 to limit the quantity of advertisements received and/or the date and time at which advertisements are received. For example, if a consumer allows provider 204 to send text message advertisements, but the consumer has a text messaging plan with a limited number of available text messages, and the consumer may restrict the maximum number of text messages received via provider 204 on a per-day, per-week, per-month, or other basis. Even if a consumer has an unlimited number of messages that may be received, the consumer may nonetheless want to restrict the number of advertisements to, for instance, limit interruptions during the day, to reduce clutter in a text messaging or email inbox, etc. Further, if a consumer does not want messages to be received at night, during work hours, while in school or class, etc., the consumer may also specify a “black out” period or other time period in which he or she does or does not wish to receive advertisements. Consumers may also specify an advertisement frequency. For example, a consumer may specify that no more than one advertisement should be received per hour, per day, etc.

In some circumstances, incentives for receiving advertisements may vary based on the particular advertisement. For example, an advertisement allowing consumers to reply and have his or her contact information shared with an advertiser will incur a higher cost from advertiser, and that higher cost may be proportionally shared with the consumer. Advertisements sent to very small audiences may also carry a different cost than generic advertisements or advertisements sent to larger audiences. When advertisers can pay different amounts for an advertisement, consumers may receive different incentives. Accordingly, through consumer interface 207, consumers may be able to select only to receive advertisements of a certain type, incentive level, and the like.

Consumer interface 207 may also track account information. By way of example, when provider 204 provides incentives to consumers for receiving text messages, account information may keep a running total of the incentives available to a particular consumer. The account information may also track the manner in which the consumer wishes to receive compensation or incentives. Accordingly, consumers may request monetary payments to be mailed or to be directly deposited to a bank account. Consumer may additionally or alternatively request that credits be applied to phone or other bills. Consumers may also request certain type of gift cards, vouchers, etc. that are provided by provider 204 or a third party. Rewards may be sent automatically to consumers upon the occurrence of certain events. For example, rewards may be sent when a total reward account reaches a particular value, at the end of each month or quarter, or when a consumer logs-in and requests payment. Consumer interface 207 may also keep track of advertisements received by consumers. As such, a history may identify advertisers and the content of advertisements, money/credit earned per message, and possibly allow consumers to interact with advertisers or provider 204. For example consumers may be able to reply to a message, block an advertiser, etc. via consumer interface 207.

Advertisers may want to reach a target audience, and consumers are likely to want advertisements related to products, stores, or other factors that are of some interest to the consumers. To facilitate alignment of the interests of the advertisers with the interests of the consumers, provider 204 includes storage 209 and matching module 211. In particular, storage 209 stores information about advertisers and/or consumers. For example, demographic data and interests of consumers may be stored in storage 209, which may take the form of a database, table, or other storage mechanism.

When an advertisement is received from an advertiser, matching module 211 may execute a routine or process that identifies which consumers match criteria specified by the advertiser. For example, if an advertiser provides no criteria, the advertisement may be intended for generic, mass-distribution whereas specific criteria may match a much more limited number of consumers.

In some embodiments, matching module 211 calculates the number of matches and returns that number to advertisers to allow the advertisers to determine how many advertisements to send. In some circumstances, matching module 211 may also return additional information. For example, particularly where a very large number of matches are found, matching module 211 may select some information to allow an advertiser to potentially narrow the number of advertisements sent. For example, an advertiser that selects to target all males over the age of eighteen that are interested in sports may correspond to a very high number of matching consumers. When that number is returned, matching module 211 may return the number alone, or may break down the information based on other information (e.g., location, particular sports of interest, etc.). In other circumstances, a very small number of consumers may match specified criteria, and matching module 211 may indicate how the number of consumers changes by eliminating or expanding certain criteria. Thus, in some circumstances, matching module 211 can act as a suggestion mechanism to identify other potentially relevant criteria or expand the criteria, and may provide some of the criteria, even without identifying specific consumers.

Before and/or after matching module 211 has identified how many matching consumers are found, scheduler 213 may begin scheduling distribution of the advertisements. In some cases, scheduler 213 may determine that a potentially matching consumer cannot receive a particular advertisement due to the maximum number of messages allowed by the consumer having already been reached, time limits set by an advertiser not fitting in with time limits desired by the consumer, or for other reasons. In other cases, matching module 211 may determine this information itself, and allow scheduler 211 to schedule advertisement delivery only after the advertiser has identified how many advertisements to send.

Scheduler 213 may consider time/date, quantity, frequency, and other restrictions placed on advertisements by advertisers or consumers. In some circumstances, advertisers may request delivery of an advertisement well before a time window for delivery begins. Scheduler 213 may effectively create a queue into which such advertisements are placed. Different queues may exist for even the same advertisement based on, for example, when targeted consumers have requested to allow or disallow advertisement receipt.

Scheduler 213 may thus work in connection with advertisement delivery module 215 to transmit advertisements to consumers. Advertisement delivery module 215 may, for example, be a SMS or MMS module that sends text messages, or may be configured to send email or other advertisements. Advertisement delivery module 215 may even be configured to print advertisements for mailing. In operation, text message delivery module 215 may be combined with, or communicate with, scheduler 213 so as to maximize the chance that advertisements are received by consumers only at desired times and/or only on desired days.

In embodiments when advertisers pay to use the services offered through provider 204, provider 204 may also include payment processing module 217. Payment processing module 217 may be used to automatically collect and process payments from advertisers. Payment processing module 217 may be executed within a computing system in some cases, or may be otherwise configured. In at least one embodiment, an advertiser submits payment information, and based on the number of advertisements successfully delivered to consumers, payment is processed on a per-advertisement basis according to an agreement with the advertiser.

In embodiments in which consumers are incentivized to receive advertisements processed through the provider 204, provider 204 can include a payment remittance module 219. Payment remittance module 219 can track incentives owed to consumers. For example, when a consumer registers with provider 204 (e.g., via consumer interface 207), the consumer may be presented with a terms of service and agree to a particular incentive program. Based on the incentive program, payment remittance module 219 can track incentives owed to the consumer and, at appropriate times, issue payments or other incentives to the consumer. In embodiments in which profit is shared by granting consumers a portion of each advertisement sent to the consumer, for example, payment remittance module 219 may track the number of advertisements sent to the consumer and the per-advertisement cost for the advertisers. Then, based on those values and the percentage owed to the consumer, a monetary reward can be calculated.

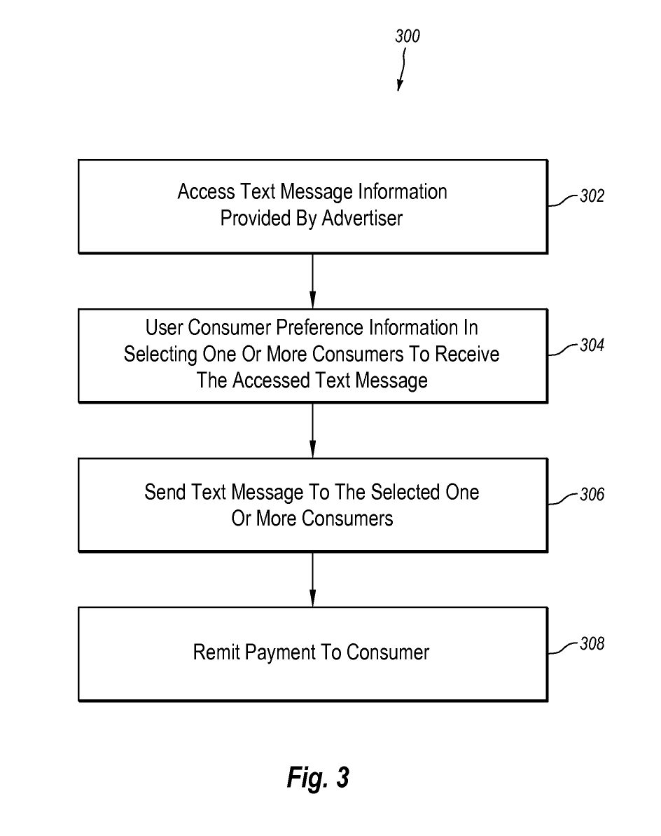

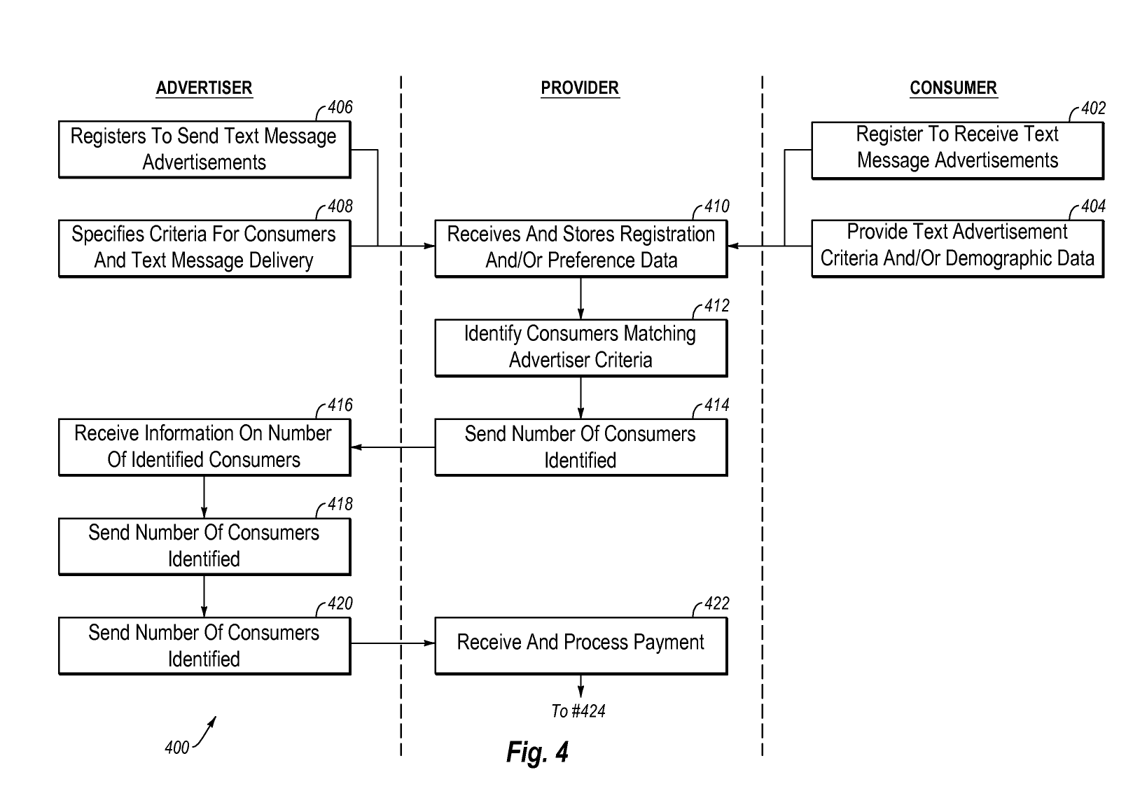

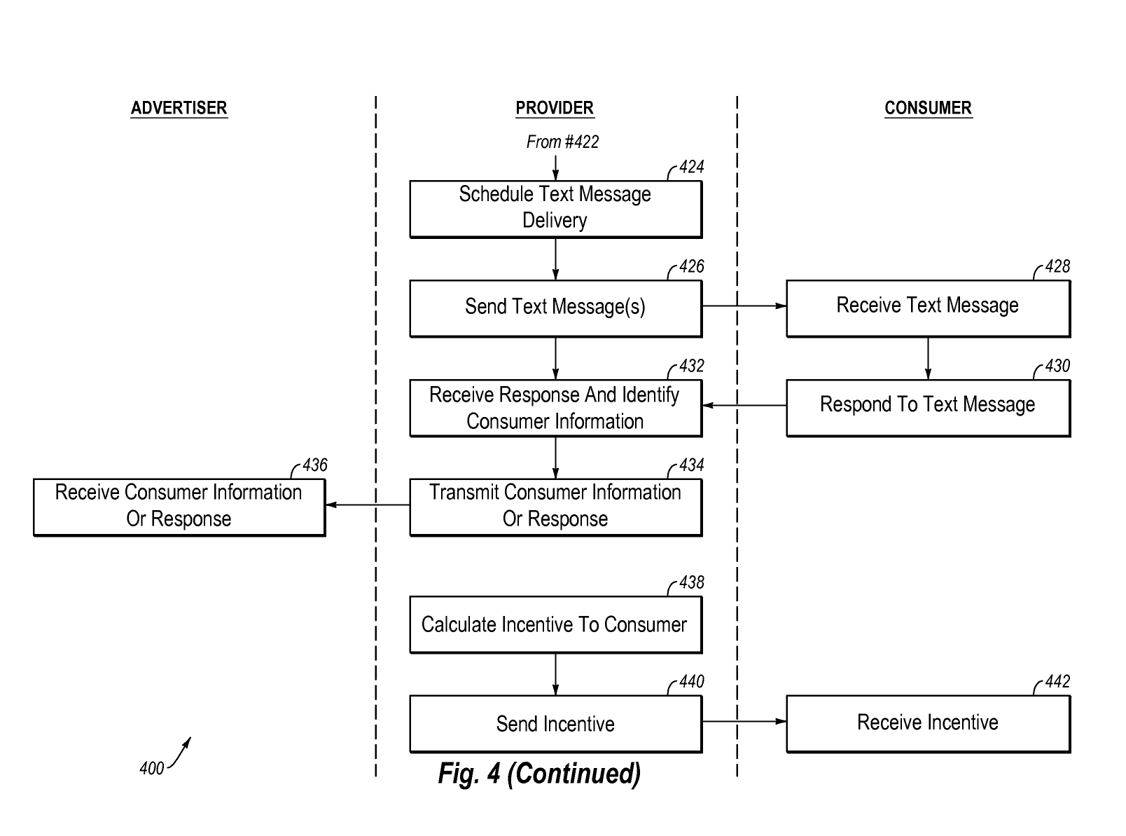

Turning now to FIG. 3, an exemplary method 300 for sending text messages and sharing profits with consumers is illustrated. Method 300 illustrates acts from the perspective of a provider (e.g., provider 104, or provider 204). It should be appreciated that method 300 is illustrative only, and that other acts or processes may be included or substituted herein. For example, FIG. 4 provides another method 400 by which advertisements can be sent and profits shared, or incentives provided, to consumers who receive the advertisements. While FIGS. 3 and 4 are discussed with reference to elements of the systems of FIGS. 1 and 2, such reference is made to clarify manners in which the disclosed methods may be performed, but is not intended to limit such method steps or acts to performance by any particular component or system.

Method 300 includes an act of accessing text message information provided by an advertiser (act 302). Act 302 can comprise accessing text message advertisement information provided by an advertiser. For example, a provider may communicate with an advertiser that wishes to send text messages or other advertisements to one or more consumers. With reference to FIG. 2, provider 204 may receive information through advertiser interface 205 about the content of a text message, the criteria of consumers who will receive the advertisement, the type of message to be sent, and the like. Provider 204 may access such information directly through advertiser interface 205, or may store and retrieve the information using storage 209.

Method 300 also includes an act of using consumer preference information in selecting one or more consumers to receive the accessed text message (act 304). Act 304 can comprise using consumer information to select one or more consumers to receive advertising content of the accessed text message advertisement information. For example, with reference to FIG. 2, consumer information stored in storage 209 and obtained through consumer interface 207 may provide certain demographic, interest, or other data about consumers. This information can be compared (e.g., by using matching module 211) to advertiser's criteria for a target audience. Consumers that match the specified advertisement criteria can then be selected to receive a text message or other advertisement.

The method 300 also includes an act of sending the text message to the selected one or more consumers (act 306). Act 306 can comprise sending a text message to one or more devices for each of the selected one or more consumers, each text message including at least some of the advertising content of the text message advertisement information provided by the advertiser. Referring to FIG. 2, for example, advertisement delivery module 215 may send or transmit a text message a portable device of each of the one or more consumers.

The method 300 also includes an act of remitting payment to the consumer (act 308). Act 308 can comprise providing at least one consumer to whom the text message advertisement was sent with an incentive, the incentive at least partially related directly to receipt by the at least one consumer of the sent text message advertisement. For example, based on an agreement with the consumers, payment remittance module 219 can remit incentives to the consumers. The consumers may receive incentives for having agreed to receive the text message. Remittance may include sending or initiating the sending of incentives to consumers through physical or electronic means, or instructing another party to remit incentives to the consumers. In some embodiments, payment remittance module 219 (or any other module/component) may initiate a mailing process (e.g., physical checks, coupons, etc.) or may instruct third party 108 to remit some form of incentive. As noted, payment may be remitted in any number of manners, including by direct monetary compensation, as gift cards or vouchers, as credits, or in any number of other manners.

Turning now to FIG. 4, illustrated is an exemplary method 400 for sending text messages and sharing profits with consumers. In particular, method 400 includes exemplary acts performed by each of a provider, an advertiser, and a consumer.

As depicted, method 400 can include acts of a consumer registering to receive text message advertisements (act 402) and providing text advertisement criteria and/or demographic data (act 404). For example, consumer 106 may register with provider 104 to receive advertisements. Consumer 106 may also limit the time or scope of advertisements, and may provide information about hobbies, interests, and the like. Such registration, criteria, demographic, and other information may be transmitted to provider 104.

In a similar manner, method 400 can include acts of an advertiser registering to send text message advertisements (act 406) and specifying criteria for consumers and text message delivery (act 408). For example, advertiser 102 may register with provider 104. Advertiser 102 may also specify the type of consumer they wish to target with advertisements (e.g., by entering demographic or interest data), may specify the timeframe in which text message advertisements should be delivered to consumers, and may specify other information. This information may also be transmitted to provider 104.

Method 400 also includes an act of the provider receiving and storing registration data and/or preference data (act 410). Act 410 can comprise receiving registration information from a consumer, the registration information including consent by the consumer to receive electronic advertisements and receiving at least one electronic advertisement and target consumer criteria from one or more advertisers. For example, a web application, server, or other mechanism of provider 104 may receive certain information from advertiser 102 and/or consumer 106 (e.g., in acts 402, 404, 406, and/or 408). The information from consumer 106 may relate to the consumer's contact information, demographic data, hobbies, interests, advertising time, frequency, and quantity limits, and the like. The information from advertiser 102 may include one or more advertisements, information about a target audience, timeframe for delivery, and the like. Provider 104 can store this information for contemporaneous and/or later access.

Method 400 also includes an act of identifying consumers matching advertiser criteria (act 412). Act 412 can comprise determining that the consumer qualifies to receive the at least one electronic advertisement. For example, consumer 106 may have demographic and interest data matching criteria specified by advertiser 102, and may also have time or quantity limits that allow consumer 106 to receive text messages at the time specified by advertiser 106. Act 412 can include comparing advertisement criteria with aggregate consumer information about multiple consumers to select particular consumers to whom the advertisement should be sent.

Method 400 can also include acts of sending the number of consumers identified (act 414) and receiving information of the number of identified consumers (act 416). For example, provider 104 can send advertiser 102 the number of matching consumers. Advertiser 102 can, in turn, receive the information.

Method 400 can include acts of selecting a number of consumers (act 418), sending the number of users and payment information (act 420), and receiving and processing payment (act 422). Act 422 can comprise receiving payment from the one or more advertisers, the received payment being on a per-advertisement basis. For example, advertiser 102 may have previously selected a number of advertisements to send, or may not have. If advertiser 102 did not earlier select the number of advertisements to send, if an earlier selected number of advertisements could not be sent, or for other reasons, advertiser 102 may select the number of consumers to receive the advertisement. Such number may be sent to provider 104. Before, after, or along with the number of consumers, payment information for how advertiser 102 should be billed or pay for the sent advertisements may also be transmitted from advertiser 102 to provider 104.

As such, provider 104 can receive the number of users and the payment information, and process payment. In processing payment, the payment may be processed and charged immediately, or may be wholly or partially deferred. For example, payment may be deferred until the text message advertisements are sent.

Method 400 can also include an act of scheduling text message advertisements for delivery (act 424). In some cases, advertisements may be sent immediately, while others may be deferred. For example, advertisements may be stored in a queue. Deferment may result from an availability time window set by one or more of consumer 106 or advertiser 102, such that delay may be independent of whether other advertisements take precedence or were earlier received. In other cases, an advertisement may be sent at multiple different times—and even dozens or hundreds of different times—depending on when consumers are available to receive the text message advertisements.

Method 400 can also include an act of sending a text message (act 426). Act 426 can comprise transmitting the at least one electronic advertisement to a portable device of the consumer. For example, provider 104 can send one or more text messages to consumer 106 (e.g., to portable device 116). Text messages sent from provider 104 to consumer 104 may pass through any number of different network connections.

Correspondingly, method 400 includes an act of receiving the text message (act 428). For example, consumer 106 can receive the text message sent by provider 104. An advertisement may also be provided, and thus received, in any suitable manner. Where the advertisement is a text message, the consumer may receive the text message on a mobile phone or other portable device. Advertisements may, however, take the form of email, IVR, mailer, or other format, and thus the advertisement may be received in another manner.

Method 400 can include an act of responding to the text message (act 430) and an act of receiving a response and identifying consumer information (act 432). For example, consumer 106 may receive a text message initiated by advertiser 102 that includes an indication that consumer 106 can reply to the message to authorize advertiser 102 to contact consumer 106 directly. In some embodiments, consumer 160 may reply by identifying advertiser 102 in the response, by selecting a link in the original advertisement, by entering a code or key word such as “Call me,” “Send more info,” “Contact me,” or any other keyword, and placing the keyword in the response, or in any other suitable manner. In one example, the consumers' mobile phone or other device may recognize that consumer 106 is responding and send the response to provider 104.

Method 400 can also include acts of transmitting consumer information or response (act 434) and receiving consumer information or response (act 436). For example, provider 104 can forward the consumer's response directly to advertiser 102. Additionally, or alternatively, provider 104 can determine that consumer 106 has authorized provision of his or her contact information to advertiser 102, and send the contact information to advertiser 102. For example, provider 104 may send an email that includes information about consumers who have responded to a targeted advertisement, the information consumers who have responded can be provided at an advertiser interface specific to the advertiser. Any other mechanism for conveying the information may also be used. Advertiser 102 may then contact consumer 106 in any suitable manner as allowed by consumer 106 and the provided contact information, and may even bypass interaction with provider 104.

Responding to a received text message or other advertisement (act 430) may be used for numerous purposes other than consumers providing contact information to providers or advertisers. For example, response from consumer 106 may serve as an authorization from consumer 106 to make a purchase of goods or services. In some embodiments, advertiser 102 may advertise a product or service, and by responding to the advertisement consumer 160 authorizes provider 104 to purchase such good or service on the consumer's behalf. The payment may be debited from the consumer's account with provider 104, or an additional payment transaction may be initiated. Provider 104 may request shipment of a product, either to provider 104 or to consumer 106. If the product is shipped to provider 104, then provider 104 can forward the product to consumer 106. Alternatively, provider 104 may provide the consumer's shipping information to advertiser 102, and make payment for the good or service on behalf of consumer 106.

In another embodiment, responding to the received text message or other advertisement (act 430) can initiate a series of interactions or continuing dialog between advertisers and consumers. For example, advertiser 102 may be interested in what consumer 106 thinks of the advertiser's products, services, or even advertisement. By responding, consumer 106 can provide feedback about the product, service, or advertisement, and continue to remain anonymous, with provider 104 acting as an intermediary. As a result, advertiser 102 may potentially gather information, conduct surveys, run polls, etc. on any of a number of different topics, and can even pose multiple questions.

As one example, by responding to a first question, consumer 106 may receive a second question from advertiser 102, and so on until a multi-question survey is completed. In some circumstances, consumer 106 may authorize provider 104 to provide the consumer's personal or contact information to advertiser 102, but such authorization may follow a second, third, or other correspondence other than the first advertisement. Thus, multiple responses, or a specific response in one of a set of subsequent messages or communications following the initial advertisement, may provide the authorization of consumer 106 to provide the consumer's contact information to advertiser 102.

In the case of multiple-interactions, each additional interaction may result in an additional fee to advertiser 102, or the initial fee may include such additional interactions. Fees may also change, such that subsequent messages are more or less expensive to advertiser 102 relative to a fee for an initial advertisement. For example, when consumer 106 replies requesting more information, a higher fee may potentially be charged as an interested consumer base is identified. In contrast, quantity discounts could be applied, so that as additional advertisements or information are sent out lower rates may be applied. For an advertiser paying a fixed fee, there may be no additional charge for subsequent communications. One skilled in the art will thus appreciate that the fees for initial and/or subsequent communications, if any, can vary widely based on any number of factors.

The mechanism by which provider 104 determines use of a response may vary from advertiser to advertiser, system to system, embodiment-to-embodiment, advertisement-type to advertisement-type, or the like. For example, in an email-based advertisement system, a consumer may merely need to click on a link, which may trigger a server request that can be used by provider 104. In a text message-based advertisement system, a response may be solicited. In any case, different key words, links, or the like may be used to differentiate different actions so as to allow provider 104 to determine which one of multiple different courses of action should be pursued.

Method 400 may also incentivize consumers to allow text message advertisements to be sent and received. Method 400 can include acts of calculating an incentive to the consumer (act 438), sending the incentive to the consumer (act 440) receiving the incentive (act 442). For example, method 400 can comprise sharing the received payment with the consumer by providing a reward to the consumer. Incentives may take any form as noted herein. For example, a certain amount of money may be credited to consumers based on the number and/or type of advertisements received. Although not necessarily true for all embodiments, targeted advertisements may generate more money than generic advertisements, advertisements soliciting responses may generate more money than other advertisements, or the advertisements may otherwise vary in monetary compensation. When a consumer has earned sufficient money, requests payment, or it is otherwise determined that the incentive should be paid to the consumer, the consumer may be issued a check or paid through some other arrangement. Such incentives may be paid directly by the provider, or may be passed through one or more third parties.

The discussion herein refers to a number of methods and method steps and acts that may be performed. It should be noted, that although the method steps and acts may be discussed in a certain order or illustrated in a flow chart as occurring in a particular order, no particular ordering is necessarily required unless specifically stated in the appended claims, or required because an act is dependent on another act being completed prior to the act being performed. Moreover, no particular step or act is required unless expressly recited as so being.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Although the foregoing embodiments have been described in some detail by way of illustration and example, for purposes of clarity and understanding, certain changes and modifications will be obvious to those with skill in the art in view of the disclosure herein. The described embodiments are to be considered in all respects only as illustrative and not restrictive. Thus, all changes which come within the meaning and range of equivalency of the claims are to be embraced within their scope.

What is claimed is:

1. A method, implemented at a computer system that includes one or more processors, for transmitting text message advertisements to portable devices capable of receiving text messages, the method comprising:
an act of the computer system accessing text message advertisement information provided by an advertiser;
an act of the computer system using consumer information to select one or more consumers to receive advertising content of the accessed text message advertisement information;
an act of the computer system sending a text message advertisement to one or more devices for at least one of the selected one or more consumers, each text message advertisement including at least some of the advertising content of the text message advertisement information provided by the advertiser; and
an act of the computer system providing at least one consumer to whom the text message advertisement was sent with an incentive, the incentive at least partially related directly to receipt by the at least one consumer of the sent text message advertisement.

2. The method as recited in claim 1, wherein the act of accessing the text message advertisement information provided by the advertiser comprises:
an act of the computer system accessing the advertising content; and
an act of the computer system accessing target consumer criteria, the target consumer criteria specifying one or more conditions for identifying the one or more consumers to receive the advertisement content.

3. The method as recited in claim 1, wherein the text message advertisement information includes target consumer criteria that specifies one or more conditions for identifying the one or more consumers to receive the advertisement content, the target consumer criteria including one or more of:
target consumer demographic criteria;
target consumer hobby or interest criteria;
target consumer availability criteria;
target consumer device type criteria; or
advertisement transmission date or time criteria.

4. The method as recited in claim 1, wherein the act of using consumer information to select one or more consumers to receive the text message advertisement includes accessing consumer contact information provided by each of the one or more consumers.

5. The method as recited in claim 1, wherein the act of using consumer information to select one or more consumers to receive the text message advertisement includes an act of accessing consumer preference information provided by each of the one or more consumers.

6. The method as recited in claim 5, wherein the consumer preference information includes any combination of one or more of:
demographic information;
hobby or interest information;
time or date preference information;
maximum number of text message advertisements;
maximum frequency of text message advertisements;
blocked advertiser information; or
blocked content information.

7. The method as recited in claim 1, wherein the act of using consumer information to select one or more consumers to receive the text message advertisement includes comparing consumer preference information with target consumer criteria provided by the advertiser, and selecting only the one or more consumers with consumer preference information matching the target consumer criteria.

8. The method as recited in claim 1, wherein the incentive is based at least partially on a number of text messages advertisements received by the at least one consumer.

9. The method as recited in claim 1, wherein the act of providing the at least one consumer with an incentive comprises one or more of: (i) initiating sending of a monetary payment to the at least one consumer, or (ii) crediting an account associated with the at least one consumer, wherein the monetary payment and the credit are based on profit sharing for text message advertisements received by the at least one consumer.

10. A method, implemented at a computer system that includes one or more processors, for incentivizing consumers to receive text message advertisements, the method comprising:
an act of the computer system receiving registration information from a consumer, the registration information including consent by the consumer to receive electronic advertisements;
an act of the computer system receiving at least one electronic advertisement and target consumer criteria from one or more advertisers;
an act of the computer system determining that the consumer qualifies to receive the at least one electronic advertisement;
an act of the computer system transmitting the at least one electronic advertisement to a portable device of the consumer;
an act of the computer system receiving payment from the one or more advertisers; and
an act of the computer system sharing the received payment with the consumer by providing a reward to the consumer.

11. The method as recited in claim 11, wherein the act of receiving registration information from a consumer includes receiving any combination of one or more of the following:
contact information of the consumer;
advertisement preference information of the consumer;
payment information of the consumer; or
incentive preference information.

12. The method as recited in claim 11, wherein the payment information of the consumer includes information regarding an account to be charged for purchases made on behalf of the consumer.

13. The method as recited in claim 11, wherein the incentive preference information includes account information associated an account to be credited for incentives provided to the consumer.

14. The method as recited in claim 10, wherein the act of sharing the received payment with the consumer includes one or more of:
transferring a monetary payment to the consumer, the transferred monetary payment being based on a percentage of the received payment; or
transferring an incentive to the consumer, a value of the incentive being based on a percentage of the received payment.

15. The method as recited in claim 10, wherein the act of transmitting the at least one electronic advertisement to a portable device of the consumer includes an act of scheduling transmission of the at least one electronic advertisement based on one or more of:
limited availability specified by the consumer;
limited advertisement date/time information specified by the one or more advertisers; or
a maximum number of electronic advertisements specified by the consumer.

16. The method as recited in claim 10, further comprising:
an act of the computer system receiving from the consumer a response to the transmitted at least one electronic advertisement; and
in response to the computer system receiving the response from the consumer, the computer system performing one or more of the following:
providing the received response to the one or more advertisers;
sending to the consumer a follow-up advertisement or other information related to the one or more advertisers;
authorizing a purchase on behalf of the consumer; or
sending to the one or more advertisers personal contact information of the consumer.

17. The method as recited in claim 16, wherein in response to the computer system receiving the response from the consumer, the computer system authorizes a purchase on behalf of the consumer, the method further comprising using account payment information of the consumer to perform one or more of the following:
place a charge on a credit card associated with the consumer;
place a charge on a debit card associated with the consumer;
charge on a bank account associated with the consumer; or
reduce a value of a reward account associated with the consumer.

18. The method as recited in claim 10, wherein the act of transmitting the at least one electronic advertisement to a portable device of the consumer includes an act of sending in the text message advertisement a key word or pass phrase for inclusion in a response by the consumer, wherein inclusion of the key word or pass phrase in the response by the consumer indicates one or more of:
authorization from the consumer to share personal contact information of the consumer with the one or more advertisers;
authorization from the consumer to purchase a good or service;
authorization from the consumer to continue a survey or other dialog with the one or more advertisers;
a trigger for providing feedback from the consumer to the one or more advertisers;
a request for additional information about the one or more advertisers or their respective goods or services; or
a request for blocking future advertisements from one or more advertisers.

19. A method, implemented at a computer system that includes one or more processors, for transmitting an advertisement to a consumer, the method comprising:
an act of the computer system accessing advertisement information of an advertiser, the advertisement information including at least advertising content and consumer criteria;
an act of the computer system accessing aggregate consumer information, the aggregate consumer information relating to a plurality of consumers;
in response to the computer system accessing the advertisement information, an act of the computer system automatically:
comparing at least a portion of the consumer criteria with the aggregate consumer information; and
selecting one or more consumers to receive the advertising content;
an act of the computer system sending an advertisement to each of the selected one or more consumers, the advertisement including at least some of the advertising content; and
an act of the computer system providing an incentive to each of the selected one or more consumers, the incentive calculated based on one or more advertisements sent to each consumer.

20. The method as recited in claim 19, wherein the advertisement is sent via one or more of text message, interactive voice response (IVR), or email.
